(19) United States
(12) Patent Application Publication
(10) Pub. No.: US 2020/0108835 A1
(43) Pub. Date: Apr. 9, 2020

(54) SERVER, INFORMATION PROCESSING METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/567,125

(22) Filed: Sep. 11, 2019

(30) Foreign Application Priority Data
Oct. 4, 2018 (JP) 2018-189521

(51) Int. Cl. B60W 40/06; G08G 1/01; G08G 1/0967; G07C 5/00

(52) U.S. Cl. CPC B60W 40/06; G08G 1/0141; G08G 1/096791; B60W 2550/20; B60W 2550/408; B60W 2510/18; B60W 2520/06; G07C 5/008

(57) ABSTRACT

A server includes a server communication unit configured to communicate with a plurality of vehicles including a first vehicle and a second vehicle traveling behind the first vehicle; and a server controller configured to acquire vehicle information of the vehicles, configured to determine an abnormality classification of a road abnormality based on vehicle information of the first vehicle, configured to acquire first road information from the first vehicle, configured to determine correctness of the abnormality classification based on the first road information acquired from the first vehicle, and configured to output a warning according to the abnormality classification to the second vehicle.

### INCORPORATION BY REFERENCE

The disclosure of Japanese Patent Application No. 2018-189521 filed on Oct. 4, 2018 including the specification, drawings and abstract is incorporated herein by reference in its entirety.

### BACKGROUND

### 1. Technical Field

The present disclosure relates to a server, an information processing method, and a non-transitory storage medium storing a program.

### 2. Description of Related Art

A technology for detecting a road abnormality from road information or vehicle information in order to warn a vehicle behind is disclosed. For example, Japanese Unexamined Patent Application Publication No. 2002-044647 (JP 2002-044647 A) discloses a technology for imaging an imaging range including a microphone with a movable camera and detecting a road abnormality when a slip sound or a collision sound of a vehicle is detected by the microphone. Further, for example, WO 2018/003278 discloses a technology for determining a sudden steering wheel manipulation for avoiding a falling object from a lateral acceleration change amount or a steering angular velocity change amount per unit time of a vehicle and detecting a road abnormality.

### SUMMARY

However, the technologies of JP 2002-044647 A and WO 2018/003278 do not include a scheme for verifying correctness of content of the detected road abnormality.

The present disclosure provides a server capable of accurately detecting a road abnormality, an information processing method, and a non-transitory storage medium storing a program.

A first aspect of the present disclosure relates to a server. The server includes a server communication unit and a server controller. The server communication unit is configured to communicate with a plurality of vehicles including a first vehicle and a second vehicle traveling behind the first vehicle. The server controller is configured to acquire vehicle information of the vehicles, determine an abnormality classification of a road abnormality based on vehicle information of the first vehicle, acquire first road information from the first vehicle, determine correctness of the abnormality classification based on the first road information acquired from the first vehicle, and output a warning according to the abnormality classification to the second vehicle.

In the server according to the first aspect, the server controller may be configured to output a question regarding the abnormality classification to the first vehicle, and acquire an answer to the question from the first vehicle as the first road information.

In the server according to the first aspect, the question may differ in content according to the abnormality classification, and be answered positively or negatively.

In the server according to the first aspect, the server controller may be configured to acquire second road information from the second vehicle, and determine elimination of the road abnormality based on the second road information acquired from the second vehicle.

A second aspect of the present disclosure relates to an information processing method. The information processing method includes causing a server to communicate with a plurality of vehicles including a first vehicle and a second vehicle traveling behind the first vehicle; causing the server to acquire vehicle information of the vehicles; causing the server to determine an abnormality classification of a road abnormality based on vehicle information of the first vehicle; causing the server to acquire road information from the first vehicle; causing the server to determine correctness of the abnormality classification based on the road information acquired from the first vehicle; and causing the server to output a warning according to the abnormality classification to the second vehicle.

A third aspect of the present disclosure relates to a non-transitory storage medium storing a program. The program causes a server to: communicate with a plurality of vehicles including a first vehicle and a second vehicle traveling behind the first vehicle, acquire vehicle information of the vehicles, determine an abnormality classification of a road abnormality based on vehicle information of the first vehicle, acquire road information from the first vehicle, determine correctness of the abnormality classification based on the road information acquired from the first vehicle, and output a warning according to the abnormality classification to the second vehicle.

According to the server, the information processing method, and the non-temporary storage medium storing the program of the respective aspects of the present disclosure, it is possible to accurately detect the road abnormality.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram illustrating a schematic configuration of an information processing system according to an embodiment of this disclosure;

FIG. 2 is a block diagram illustrating a schematic configuration of a vehicle;

FIG. 3 is a diagram illustrating an example of installation of a driving assistance device in a vehicle;

FIG. 4 is a block diagram illustrating a schematic configuration of a server;

FIG. 5 is a diagram illustrating an example of a management database stored in a server;

FIG. 6 is a diagram illustrating an example in which a road abnormality has occurred;

FIG. 7 is a diagram illustrating a state in which a road abnormality has been eliminated;

FIG. 8 illustrates an example of a sequence diagram illustrating an information processing method for a server; and

FIG. 9 is a sequence diagram subsequent to FIG. 8.

### DETAILED DESCRIPTION OF EMBODIMENTS

In the drawings to be used in the following description, parts having the same configuration may be denoted with the same reference numerals and repeated description may be omitted.

### Configuration of Information Processing System

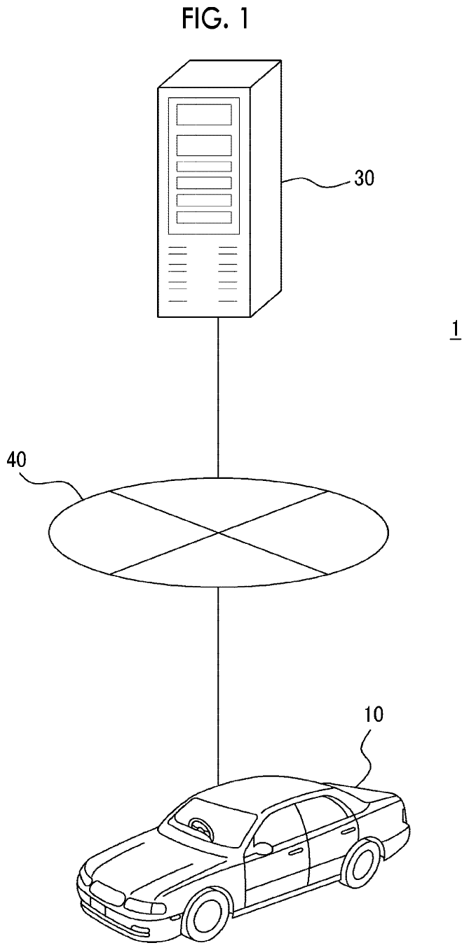

FIG. 1 is a diagram illustrating a schematic configuration of an information processing system 1. The information processing system 1 includes one or more vehicles 10 and a server 30. Although solely one vehicle 10 is illustrated in FIG. 1 for ease of description, any number of vehicles 10 provided in the information processing system 1 may be determined. In the embodiment, the number of vehicles 10 is plural. The vehicle 10 and the server 30 are connected to a network 40 such as the Internet, for example.

The vehicle 10 is, for example, a car, but is not limited thereto and may be any car on which a human can get. The server 30 includes one or a plurality of server devices capable of communicating with each other. The server 30 is installed at, for example, an information center that collects and analyzes information on the vehicle 10. In the embodiment, the server 30 will be described as one server device for ease of description.

In the information processing system 1 according to the embodiment, the vehicle 10 and the server 30 cooperate with each other to execute user assistance for detecting a road abnormality and giving a warning. Details of user assistance to be executed by the information processing system 1 will be described below.

### Configuration of Vehicle.

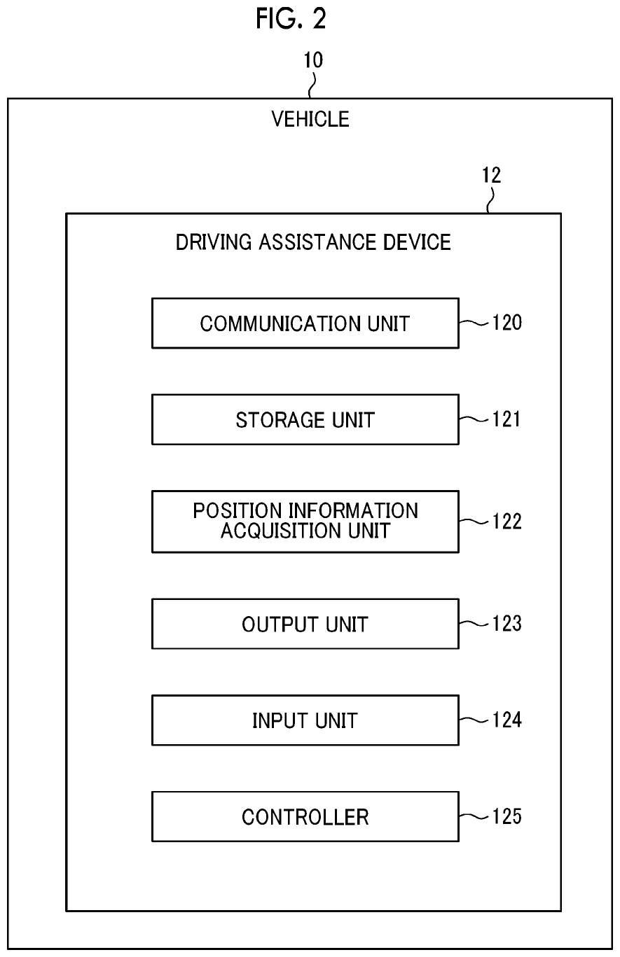

As illustrated in FIG. 2, the vehicle 10 includes a driving assistance device 12. The driving assistance device 12 is communicatively connected to the vehicle 10 via, for example, a vehicle-mounted network such as a controller area network (CAN), or a dedicated line.

The driving assistance device 12 is a device that performs driving assistance of the vehicle 10. Driving assistance includes, for example, provision of traffic information, but is not limited thereto. The driving assistance may include, for example, route guidance to a destination or automatic driving. Automatic driving includes, for example, level 1 to level 5 defined in the Society of Automotive Engineers (SAE), but is not limited thereto and may be optionally defined. The driving assistance device 12 may be, for example, a navigation device that performs route guidance or a control device that performs automatic driving. The driving assistance may be performed, for example, by cooperation between the driving assistance device 12 and an electronic control unit (ECU) of the vehicle 10. Specifically, the driving assistance device 12 includes a communication unit 120, a storage unit 121, a position information acquisition unit 122, an output unit 123, an input unit 124, and a controller 125.

The communication unit 120 includes a communication module connected to the network 40. For example, the communication unit 120 may include a communication module corresponding to a mobile communication standard such as 4th Generation (4G). In the embodiment, the driving assistance device 12 is connected to the network 40 via the communication unit 120.

The storage unit 121 includes one or more memories. In the embodiment, the “memory” is, for example, a semiconductor memory, a magnetic memory, or an optical memory, but is not limited thereto. Each memory included in the storage unit 121 may function as, for example, a main storage device, an auxiliary storage device, or a cache memory. The storage unit 121 stores any information that is used for an operation of the driving assistance device 12. For example, the storage unit 121 may store a system program, an application program, identification information of the vehicle 10, map information, traffic information, and the like. Here, identification information of the driving assistance device 12 included in the vehicle 10 may be used as identification information of the vehicle 10. The information stored in the storage unit 121 may be updatable with the information acquired from the network 40 via the communication unit 120, for example.

The position information acquisition unit 122 includes one or more receivers corresponding to any satellite positioning system. For example, the position information acquisition unit 122 may include a global positioning system (GPS) receiver. The position information acquisition unit 122 acquires position information of the vehicle 10 in which the driving assistance device 12 is mounted.

The output unit 123 includes one or more output interfaces that output information to the user. For example, an output interface included in the output unit 123 is a display that outputs information as an image, and a speaker that outputs information as an audio, but not limited to these. For example, the display is a panel display or a head-up display, but is not limited thereto.

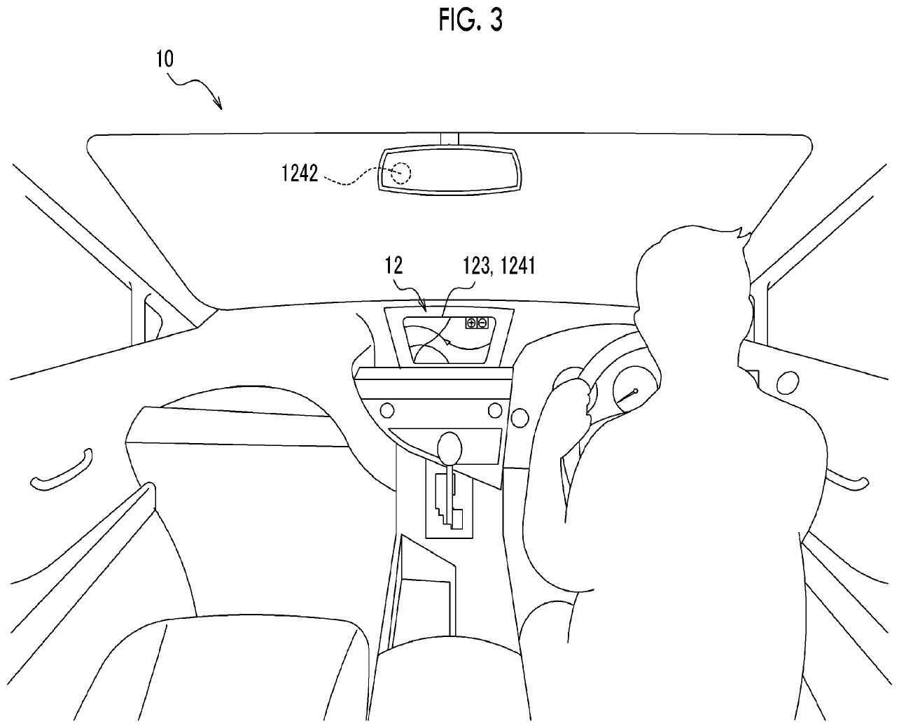

The input unit 124 includes one or more input interfaces for detecting a user input. For example, the input interface included in the input unit 124 is a touch screen 1241 (see FIG. 3) integrally provided with the panel display of the output unit 123, and a microphone that receives a voice input, but is not limited thereto.

Further, the input unit 124 includes a camera 1242 (see FIG. 3) that images surroundings of the vehicle 10. An image captured by the camera 1242 may be displayed on the output unit 123. Further, the image captured by the camera 1242 may be output to the server 30 via the communication unit 120.

The controller 125 includes one or more processors. In the embodiment, the “processor” is a general-purpose processor or a dedicated processor specialized for a specific process, but is not limited thereto. The controller 125 controls an overall operation of the driving assistance device 12.

For example, the controller 125 notifies the server 30 of the identification information of the vehicle 10, the position information of the vehicle 10, and vehicle information of the vehicle 10 acquired from the ECU via the driving assistance device 12. Here, examples of the vehicle information include a speed of the vehicle 10, an acceleration of the vehicle 10, a steering angle of the vehicle 10, an actual torque transmitted to wheels of the vehicle 10, and the presence or absence of an operation of an antilock brake system (ABS) of the vehicle 10. Here, the notification to the server 30 may be performed at any timing. For example, the controller 125 may send a notification to the server 30 each time a predetermined time (for example, one second) elapses. Further, for example, the controller 125 may send a notification to the server 30 each time the vehicle 10 travels a predetermined distance (for example, 10 m). Further, for example, when there is a request from the server 30, the controller 125 may send a notification to the server 30.

FIG. 3 is a diagram illustrating an installation example of the driving assistance device 12 in the vehicle 10. In the example of FIG. 3, the driving assistance device 12 is installed in a console panel of the vehicle 10. However, the camera 1242 included in the driving assistance device 12 is provided in an inner rear view mirror so that an environment outside the vehicle 10 in a traveling direction of the vehicle 10 can be imaged through a front window. The driving assistance device 12 includes a touch panel display in which the output unit 123 that is a panel display and the touch screen 1241 are integrally provided. The touch panel display displays a map, for example, to provide route guidance to a destination. The user can perform, for example, manipulations such as enlargement or reduction of a map by touching buttons on the touch panel display.

### Configuration of Server

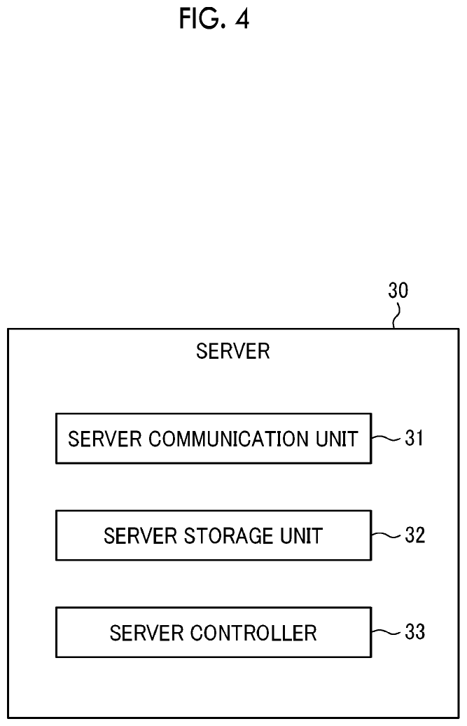

As illustrated in FIG. 4, the server 30 includes a server communication unit 31, a server storage unit 32, and a server controller 33. The server 30 is a server device that provides information for driving assistance to the driving assistance device 12. Further, the server 30 acquires road information provided from the user, via the driving assistance device 12. Further, the server 30 acquires vehicle information from the driving assistance device 12. Here, the information for driving assistance includes information on a road abnormality occurring on a road. The road abnormality includes, for example, falling object, sinking, slip, flood, closed road, or traffic jam.

The server communication unit 31 includes a communication module that is connected to the network 40. For example, the server communication unit 31 may include a communication module corresponding to a wired local area network (LAN) standard. In the embodiment, the server 30 is connected to the network 40 via the server communication unit 31.

The server storage unit 32 includes one or more memories. Each memory included in the server storage unit 32 may function as, for example, a main storage device, an auxiliary storage device, or a cache memory. The server storage unit 32 stores any information that is used for an operation of the server 30. For example, the server storage unit 32 may store a system program, an application program, map information, and a management database to be described below. The information stored in the server storage unit 32 may be updatable with information acquired from the network 40 via the server communication unit 31, for example.

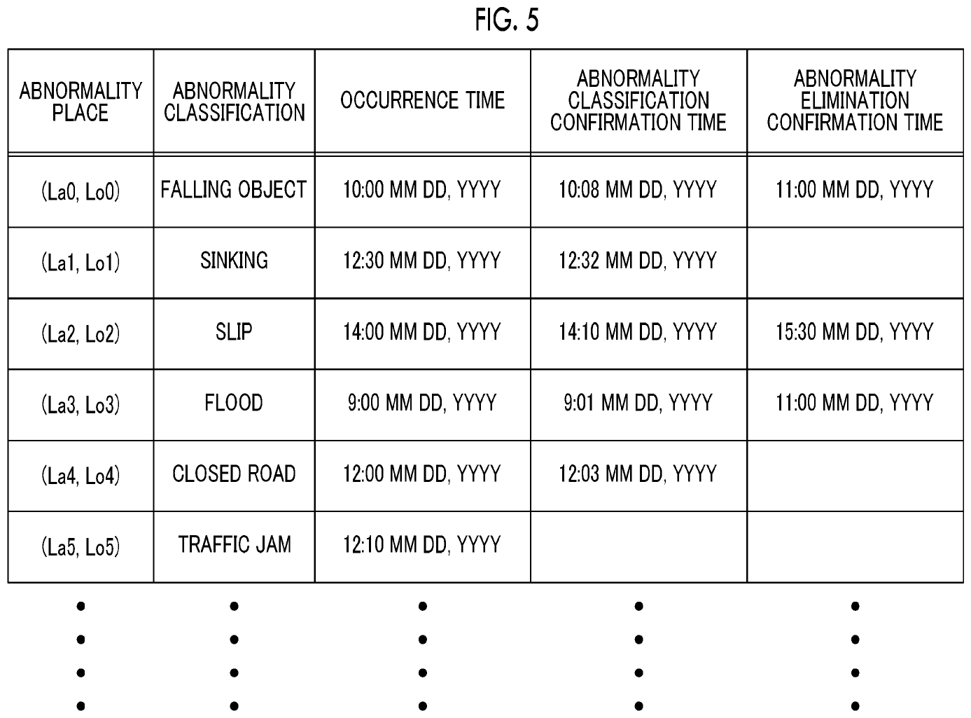

The management database includes, for example, a road abnormality table as illustrated in FIG. 5. The road abnormality table includes an abnormality place, an abnormality classification, an occurrence time, an abnormality classification confirmation time, and an abnormality elimination confirmation time.

The abnormality place is the place at which the road abnormality has occurred. In the example of FIG. 5, the abnormality place is indicated by coordinates using latitude and longitude. However, the coordinates are an example of a representation indicating a place, and other representations may be used. For example, the abnormality place may be indicated by a name of a road (for example, a highway name or a route number), a unique number of a node (for example, a nodal point on a road network representation such as an intersection), and a distance from the node.

The abnormality classification is a classification of road abnormality, and indicates content of the abnormality that has occurred. As described above, road abnormality includes, for example, the falling object, the sinking, the slip, the flood, the closed road, or the traffic jam. The falling object is a road abnormality in which there is an obstacle on a road. The sinking is a road abnormality in which there is a hole or a pit in a road. The slip is a road abnormality in which a road is slippery. The flood is a road abnormality in which a road is covered with water. The closed road is, for example, a road abnormality in which the vehicle 10 cannot pass the road due to construction or the like. The traffic jam is a road abnormality in which the vehicle 10 traveling on a road travels at a low speed (for example, 40 km/hour or less) and a line of vehicles has a certain length (for example, 1 km) or more.

The occurrence time is a time at which the road abnormality has occurred. In the embodiment, the abnormality classification of the road abnormality is determined based on the vehicle information by the server 30. For example, the occurrence time may be a time at which first vehicle information has been acquired when the server 30 determines the abnormality classification of the road abnormality. Further, as another example, the occurrence time may be a time at which the server 30 determines the abnormality classification of the road abnormality. Here, the abnormality classification determined by the server 30 based on the vehicle information includes uncertainty until a determination is made that the abnormality classification is correct based on the road information. Therefore, a determination as to the abnormality classification of the road abnormality to be executed by the server 30 may be described as “estimation of road abnormality” below. Details of the road abnormality estimation will be described below.

The abnormality classification confirmation time is a time at which the server 30 has determined that the estimation of the road abnormality is correct based on the road information. In the embodiment, the road information is provided from the user of the vehicle 10 traveling near the abnormality place. Here, there being no abnormality classification confirmation time (a specific time being not input) indicates that the server 30 has not determined that the estimation of the road abnormality is correct. In the embodiment, the user can provide the road information by answering the question from the server 30. Details of the question of the server 30 and the road information provided from the user will be described below.

The abnormality elimination confirmation time is a time at which the server 30 has determined that the road abnormality has been eliminated based on the road information. Here, there being no abnormality elimination confirmation time (the specific time being not input) indicates that the server 30 has not determined that the road abnormality has been eliminated.

In the example of FIG. 5, a falling object occurs at 10:00 on MM DD, YYYY at a position of coordinates (La0,Lo0). It is confirmed at 10:08 that the content of the road abnormality (abnormality classification) is correct. It has been confirmed at 11:00 that the road abnormality has been eliminated. Further, the sinking occurs at 12:30 on MM DD, YYYY at a position of coordinates (La1,Lo1) and is confirmed at 12:32. However, the sinking continues without being resolved. Further, the slip occurs at 14:00 on MM DD, YYYY at a position of coordinates (La2,Lo2) and is confirmed at 14:10. The slip is resolved at 15:30. Further, the flood occurs at 9:00 on NEVI DD, YYYY at a position of coordinates (La3,Lo3) and is confirmed at 9:01. The flood is resolved at 11:00. Further, the closed road occurs at 12:00 on MM DD, YYYY at a position of coordinates (La4,Lo4) and is confirmed at 12:03. However, the closed road continues without being resolved. Further, the server 30 estimates that traffic jam has occurred at 12:10 on MM DD, YYYY at a position of the coordinates (La5,Lo5). However, the traffic jam at the position of coordinates (La5,Lo5) has not yet been confirmed.

The server 30 can warn the vehicle 10 directed to the abnormality place based on the road abnormality table. In the example of FIG. 5, the server 30 can warn the vehicle 10 directed to the coordinates (La1,Lo1) that there is a sinking. Further, the server 30 can warn the vehicle 10 directed to the coordinates (La4,Lo4) that the road is closed. Further, in the example of FIG. 5, the server 30 acquires road information from the vehicle 10 near the coordinates (La5,Lo5) in order to confirm traffic jam.

The server controller 33 includes one or more processors. The processor may include, for example, a general-purpose processor and a dedicated processor specialized for a specific process. For example, the server controller 33 may be a central processing unit (CPU). The server controller 33 controls an overall operation of the server 30.

In the embodiment, the server controller 33 provides information for driving assistance to the driving assistance device 12 via the server communication unit 31. The server controller 33 manages a management database. The server controller 33 acquires road information and vehicle information provided from the user, from the driving assistance device 12. Further, the server controller 33 performs the estimation of the road abnormality. Further, the server controller 33 determines whether the estimation of the road abnormality is correct based on the road information.

Further, the server controller 33 warns the vehicle 10 directed to the abnormality place based on the road abnormality table. Further, the server controller 33 determines whether the road abnormality has been eliminated based on the road information.

### Estimation of Road Abnormality

The server controller 33 may perform the estimation of the road abnormality as follows, for example. As described above, the server controller 33 acquires vehicle information from the vehicles 10 that can communicate with the server 30. The server controller 33 determines that there is a falling object at a specific place when the server controller 33 has detected that the vehicle 10 is performing an avoidance operation at the specific place based on a lateral acceleration or a steering angle among the vehicle information. Here, the lateral acceleration is an acceleration in a direction perpendicular to a direction in which the vehicle 10 travels straight on a virtual plane parallel to the road. Further, the server controller 33 determines that the road is sinking at the specific place when the vehicle 10 suddenly moves in a vertical direction at the specific place based on an acceleration in the vertical direction among the vehicle information. Here, the vertical direction is a direction perpendicular to the road. Further, when the server controller 33 detects that an ABS of the vehicle 10 is operating at a specific place, the server controller 33 determines that a slip has occurred at the specific place. Further, the server controller 33 determines that a road is flooded at a specific place when the server controller 33 detects that the vehicle 10 receives resistance at the specific place based on an acceleration and an actual torque among the vehicle information. Further, the server controller 33 determines that a road is closed at a specific place when the server controller 33 detects that the vehicle 10 is decelerating and changing lane at the specific place based on a velocity and an acceleration among the vehicle information. Further, the server controller 33 determines that there is a traffic jam at specific section having a certain length or more when the vehicle 10 is traveling at a low speed in the specific section based on a speed among the vehicle information.

### Example of Road Abnormality

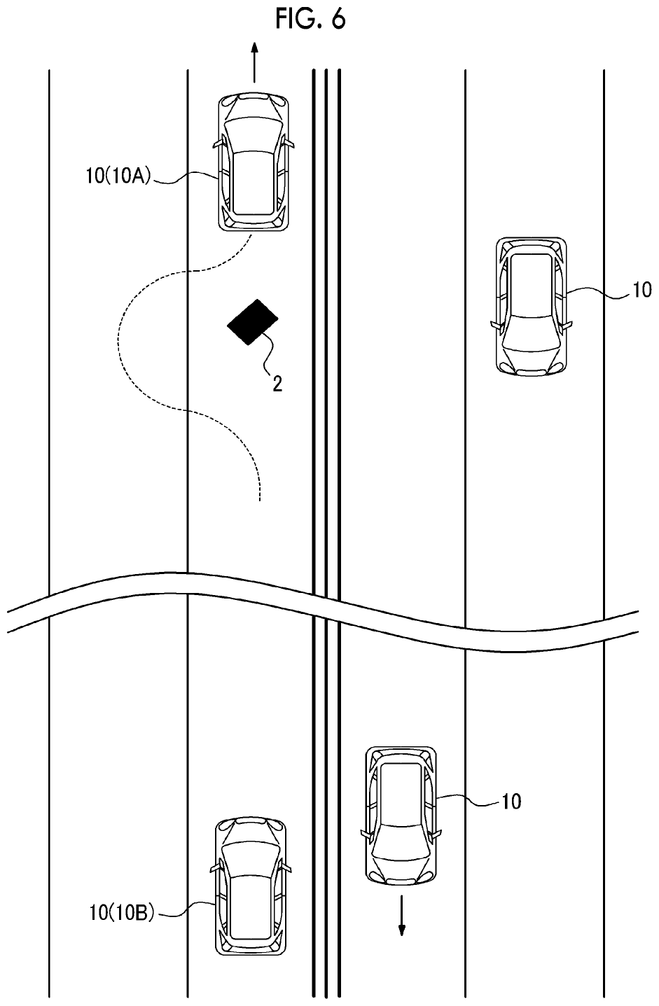

FIG. 6 is a diagram illustrating a state in which a road abnormality has occurred. In the example of FIG. 6, the road abnormality is a falling object 2. As illustrated in FIG. 6, among vehicles 10 traveling on a road, a vehicle 10A finds the falling object 2, performs an avoidance action (for example, a sudden steering manipulation), and then, travels toward the front of the falling object 2. Further, among the vehicles 10 traveling on the road, the vehicle 10B is separated from the falling object 2 and travels toward the falling object 2 behind the vehicle 10A. The server 30 communicates with the first driving assistance device 12A mounted in the vehicle 10A and the second driving assistance device 12B mounted in the vehicle 10B to warn the vehicles of the falling object 2 or to determine correctness of the estimation of the road abnormality. In the example of FIG. 6, the server 30 acquires road information from the user of the vehicle 10A via the first driving assistance device 12A. The server 30 determines whether or not the estimation of the road abnormality is correct based on the acquired road information. Further, the server 30 outputs a warning signal to the second driving assistance device 12B of the vehicle 10B traveling toward the falling object 2 behind the vehicle 10A to warn a user of the vehicle 10B of the falling object 2.

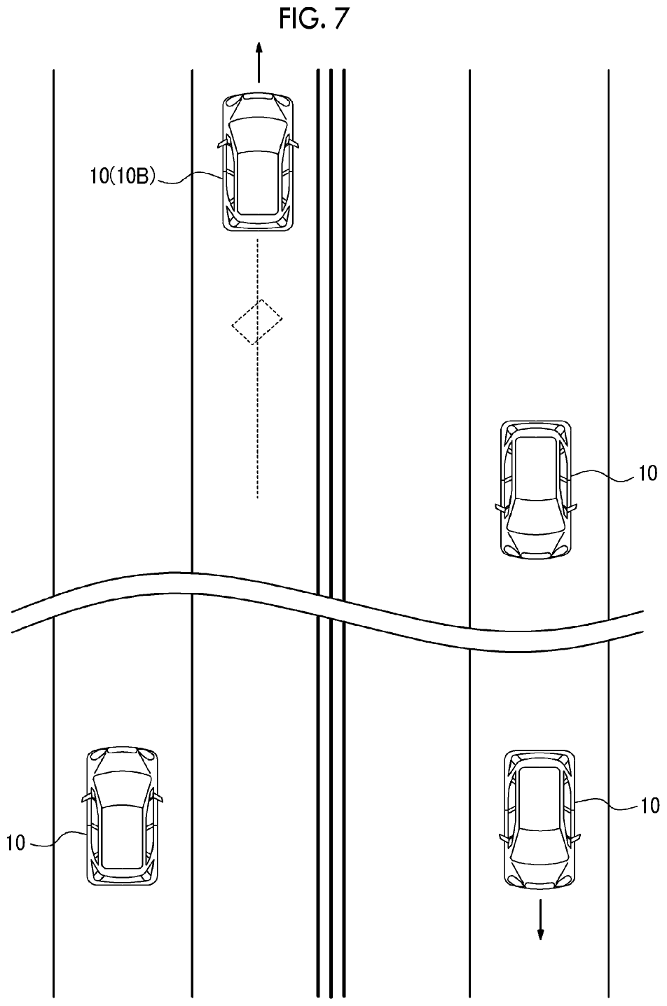

FIG. 7 is a diagram illustrating a state in which the road abnormality has been eliminated. FIG. 7 is a diagram illustrating a state of the road after FIG. 6. In the example of FIG. 7, the falling object 2 has been removed and the road abnormality has been eliminated. The vehicle 10B travels toward a place at which there has been the falling object 2. The vehicle 10B travels straight and passes through the place at which there has been the falling object 2. The server 30 communicates with the second driving assistance device 12B mounted in the vehicle 10B to determine the state of the road abnormality. In the example of FIG. 7, the server 30 determines whether the road abnormality has been eliminated based on the road information acquired from the user of the vehicle 10B.

### Communication Process

The server 30 can accurately detect a road abnormality by executing a communication process (an information processing method) to be described below.

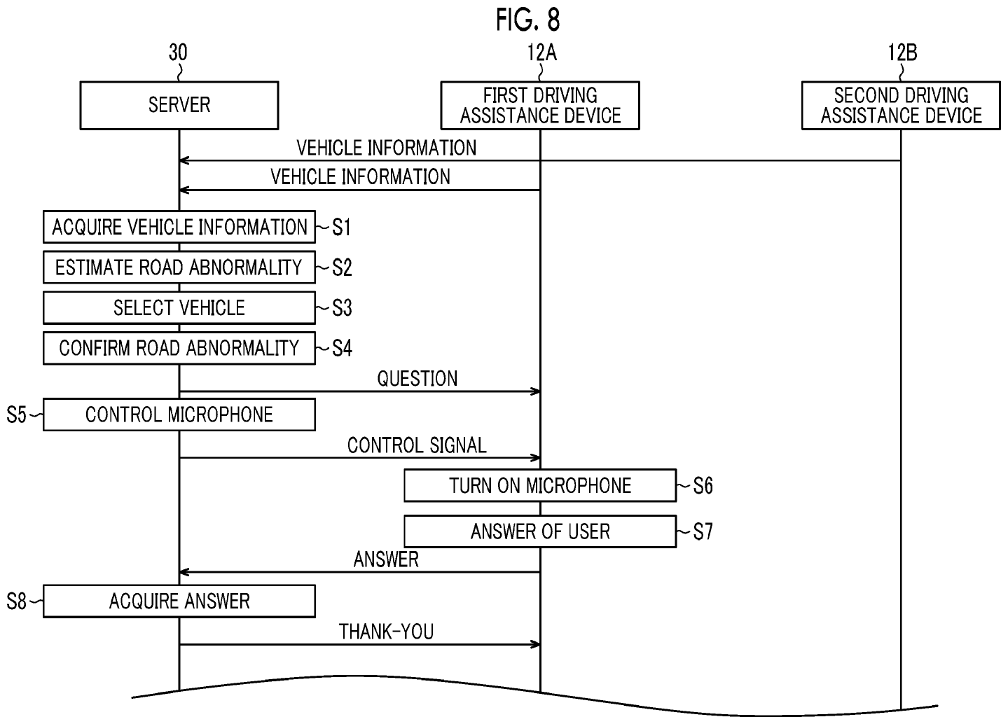

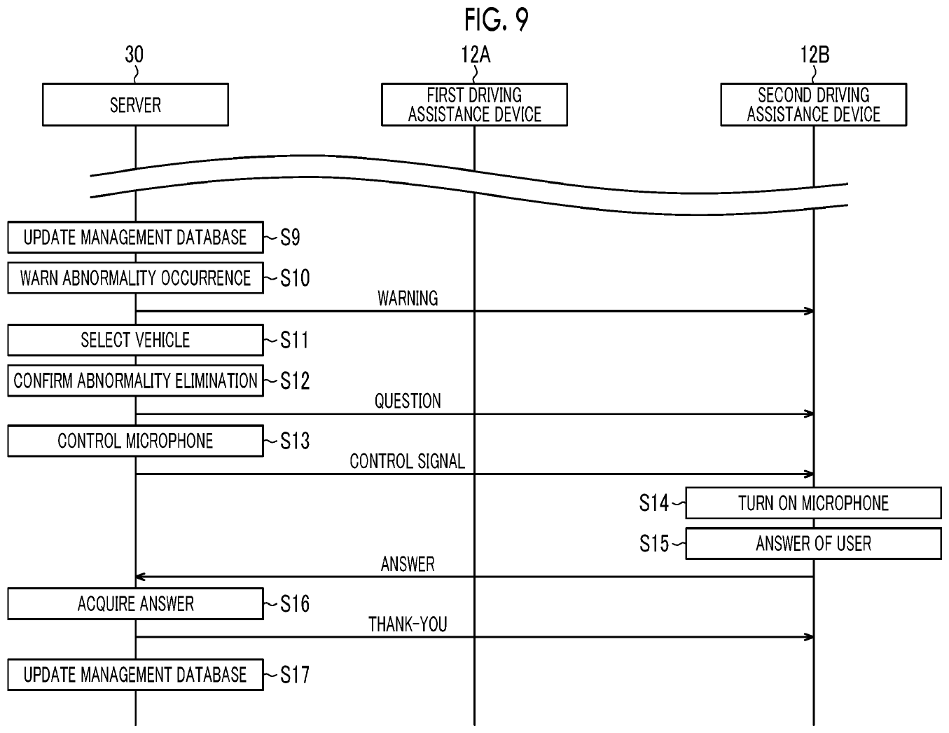

FIGS. 8 and 9 illustrate an example of a sequence diagram illustrating a communication process that the server 30 executes between the first driving assistance device 12A and the second driving assistance device 12B. The first driving assistance device 12A is mounted in, for example, the vehicle 10A (see FIG. 6) that has passed a place at which a road abnormality has occurred. Further, the second driving assistance device 12B is mounted in the vehicle 10B (see FIG. 6) that travels behind the vehicle 10A toward the place at which the road abnormality has occurred. Further, the server 30 communicates not only with the vehicle 10A and the vehicle 10B, but also with the driving assistance device 12 mounted in another vehicle 10.

The server 30 acquires vehicle information of the vehicle 10A in which the first driving assistance device 12A is mounted, from the first driving assistance device 12A. Further, the server 30 acquires vehicle information of the vehicle 10B in which the second driving assistance device 12B is mounted, from the second driving assistance device 12B. The server 30 acquires the vehicle information of the vehicle 10 in which the driving assistance device 12 is mounted, from not only the vehicle 10A and the vehicle 10B, but also the communicating driving assistance device 12 (step S1). Here, the server 30 acquires the vehicle information at a predetermined timing. The predetermined timing may be, for example, every fixed time (for example, every second).

The server 30 determines that the vehicle 10 is performing a motion different from a normal travel at a specific place based on the vehicle information of the vehicle 10. That is, the server controller 33 performs the estimation of the road abnormality using the above determination scheme (step S2). As an example, the server 30 estimates that the road abnormality of the falling object has occurred when the server 30 has detected that the vehicle 10 is performing an avoidance operation at a position of the coordinates (La0,Lo0). Here, the server 30 continues the process of step S1 when there is no motion different from the normal travel in the vehicle 10.

The server 30 selects the vehicle 10 that has provided the vehicle information for estimating the road abnormality, that is, the vehicle 10 that has performed a motion different from a normal travel (step S3). In the example of FIGS. 8 and 9, the server 30 selects the vehicle 10A in which the first driving assistance device 12A is mounted.

The server 30 communicates with the first driving assistance device 12A mounted in the vehicle 10A and performs confirmation of the road abnormality (step S4). Specifically, the server 30 outputs an audio signal of a question to the first driving assistance device 12A. The audio signal of the question is reproduced by the first driving assistance device 12A. That is, the first driving assistance device 12A outputs voice of the question from the speaker to the user of the vehicle 10A.

Here, the question is different in content according to the abnormality classification. Further, it is desirable for the question to be able to be answered positively or negatively. That is to say, the questions can be answered with “Yes” or “No”. When a question that can be answered positively or negatively is used, the user of the vehicle 10 can answer very simply as compared to uttering description of a situation of the road. That is, the user of the vehicle 10 can provide road information simply by answering with “Yes” or “No”. Further, since the server 30 that acquires the road information may determine “Yes” or “No” through speech recognition, a situation can be ascertained earlier as compared with a case in which description of a road situation is interpreted through speech recognition. That is, the server 30 can shorten a time needed for voice recognition of the answer.

The server 30 asks a question about, for example, “Is there a falling object on the road?” to the user of the vehicle 10 when the abnormality classification is a falling object. Further, the server 30 asks a question about, for example, “Does the road sink?” to the user of the vehicle 10 when the abnormality classification is sinking. Further, the server 30 asks a question about, for example, “Does the road slip?” to the user of the vehicle 10 when the abnormality classification is slip. Further, the server 30 asks a question about, for example, “Is the road flooded?” to the user of the vehicle 10 when the abnormality classification is flood. Further, the server 30 asks a question about, for example, “Is the road closed?” to the user of the vehicle 10 when the abnormality classification is a closed road. Further, the server 30 asks a question about, for example, “Does the road suffer a traffic jam?” to the user of the vehicle 10 when the abnormality classification is a traffic jam.

The server 30 executes microphone control after a question has been issued to the user of the vehicle 10 (step S5). Specifically, the microphone control is control in which the server 30 turns on a microphone of the first driving assistance device 12A mounted in the vehicle 10A using a control signal. Through the microphone control, the user of the vehicle 10A can immediately answer the question by voice, particularly, without performing a preparation manipulation.

The first driving assistance device 12A turns on the microphone, that is, activates the microphone according to a control signal from the server 30 (step S6).

When the first driving assistance device 12A obtains an answer to the question from the user (step S7), the first driving assistance device 12A outputs the answer to the server 30.

When the server 30 acquires the response from the first driving assistance device 12A (step S8), the server 30 outputs a thank-you audio signal to the first driving assistance device 12A. The first driving assistance device 12A outputs a thank-you voice from the speaker to the user of the vehicle 10A. By issuing the thank-you voice, it is possible to enhance an answering motivation for the user.

When the server 30 has obtained a positive answer from the user of the vehicle 10A, the server 30 updates the management database so that that content of the estimated road abnormality having been correct is reflected (step S9). Specifically, the server 30 stores a time at which the positive answer to the question has been obtained in the abnormality classification confirmation time of the road abnormality table. The positive answer is, for example, an answer “Yes” to the question “Is there a falling object on the road?”. That is, the positive answer in this step is an answer indicating that the correctness of the content of the road abnormality estimated by the server 30 has been confirmed by the user. Here, when the server 30 has obtained a negative answer from the user of the vehicle 10A, the server 30 may execute the process from the estimation of road abnormality (step S4) to the acquisition of the answer (step S8) again.

After the server 30 updates the management database, the server 30 gives a warning of the abnormality occurrence (step S10). The server 30 may select the vehicle 10 to be directed to the place at which the road abnormality has occurred based at the position information of the vehicle 10, and output a warning to the driving assistance device 12 mounted in the selected vehicle 10. Further, as another example, the server 30 may output a warning to all communicating vehicles 10. Here, the warning may include an image of the place at which the road abnormality has occurred. The image included in the warning is displayed on a display of the driving assistance device 12. After the server 30 updates the management database, the server 30 may cause the vehicle 10 directed to the place at which the road abnormality has occurred and closest to the place at which the road abnormality has occurred to perform image using the camera 1242. The server 30 may acquire a captured image and cause the image to be included in the above warning. The server 30 can more accurately show the place at which the road abnormality has occurred, to the user of the vehicle 10, by using the warning with the image.

After outputting the warning, the server 30 selects the vehicle 10 passing the place at which the road abnormality has occurred (step S11). In the example of FIGS. 8 and 9, the server 30 selects the vehicle 10B in which the second driving assistance device 12B is mounted.

The server 30 communicates with the second driving assistance device 12B mounted in the vehicle 10B and performs confirmation of the abnormality elimination (step S12). Specifically, the server 30 outputs an audio signal of a question to the second driving assistance device 12B. The audio signal of the question is reproduced by the second driving assistance device 12B. That is, the second driving assistance device 12B outputs the voice of the question from the speaker to the user of the vehicle 10B. Here, content of the question is the same as in step S4. For example, when the abnormality classification is a falling object, the server 30 asks a question about “Is there a falling object on the road?” to the user of the vehicle 10B.

The server 30 executes microphone control after a question has been issued to the user of the vehicle 10 (step S13). The microphone control is the same as step S5.

The second driving assistance device 12B turns on the microphone according to a control signal from the server 30 (step S14).

When the second driving assistance device 12B has obtained an answer to the question from the user (step S15), the second driving assistance device 12B outputs the answer to the server 30.

When the server 30 acquires the response from the second driving assistance device 12B (step S16), the server 30 outputs a thank-you audio signal to the second driving assistance device 12B. The second driving assistance device 12B outputs a thank-you voice from the speaker to the user of the vehicle 10B. In the process of confirmation of abnormality elimination, it is possible to enhance an answering motivation for the user by issuing a thank-you voice.

When the server 30 has obtained a negative answer from the user of the vehicle 10B, the server 30 updates the management database so that the road abnormality having been eliminated is reflected (step S17). Specifically, the server 30 stores a time at which the negative answer to the question has been obtained in the abnormality elimination confirmation time of the road abnormality table. The negative answer is, for example, an answer of “No” to the question “Is there a falling object on the road?”. That is, the negative answer in this step is an answer indicating that the user has confirmed that the road abnormality that has occurred has been eliminated. Here, when the positive answer has been obtained from the user of the vehicle 10A, the server 30 may execute the processes from the selection of the vehicle after the warning (step S11) to the acquisition of the answer (step S16) again.

As described above, after the server 30 of the information processing system 1 determines the abnormality classification of the road abnormality based on the vehicle information of the vehicle 10A, which is the first vehicle, and then, determines the correctness of the abnormality classification based on the road information acquired from the vehicle 10A. Therefore, the server 30 can accurately detect the road abnormality.

Further, as in the above embodiment, the server 30 outputs a question about the abnormality classification to the vehicle 10, and acquires an answer to the question as the road information. The user of the vehicle 10 can answer very easily as compared to uttering description of a situation of the road.

Further, as in the above embodiment, the question from the server 30 differs in content according to the abnormality classification and can be answered positively or negatively. The user of the vehicle 10 can provide the road information simply by answering with “Yes” or “No”. Further, the server 30 can easily ascertain the situation of the road and shorten a time needed for voice recognition of the answer.

Further, as in the above embodiment, the server 30 acquires the road information from the vehicle 10B, which is the second vehicle, and determines the elimination of the road abnormality based on the road information acquired from the vehicle 10B. The server 30 can also detect the road abnormality correctly since the server 30 also confirms a continued state of the road abnormality.

Although the present disclosure has been described based on all the drawings and examples, it should be noted that those skilled in the art can easily make various changes and modifications based on the present disclosure. Therefore, it should be noted that these variations and modifications are included in the scope of the present disclosure. For example, a function or the like included in each means or each step can be rearranged not to be logically contradictory, and it is possible to combine or divide a plurality of means, steps, or the like into one.

For example, the server 30 may notify the driving assistance device 12 that the road abnormality has been eliminated when the user confirms that the occurring road abnormality has been eliminated. The notification that the road abnormality has been eliminated may be voice or may be a visually identifiable message or image. Further, the server 30 may cause the warning of the occurrence of the abnormality to be displayed on the display of the driving assistance device 12 with a visually confirmable message or image, instead of or in addition to the voice.

Further, the server 30 may further classify the abnormality classification. The server 30 may execute image analysis (for example, an enlargement process, white line detection, and feature point extraction) of an image of the place at which the road abnormality has occurred, for classification. The falling object may be classified according to, for example, a position on a road (a central portion, a border of a lane, or the like) and a type (wood, metal, resin, or the like). Further, the sinking and flood may be classified according to, for example, a position on the road and a size. Further, the slip may be classified according to, for example, a range (for example, 10 m, 100 m, or 1 km), a position on the road, and a type (freezing of a road surface, earth and sand on the road surface, or the like). Further, for example, the closed road may be classified according to a type (construction, accident, or the like). Further, the traffic jam may be classified by, for example, lanes (all lanes, some of the lanes, or the like). For example, the server 30 may attach an additional message for avoidance of the road abnormality to a warning according to the classification. As an example, when the road abnormality is a slip and the type is freezing of road surface, the server 30 may attach an additional message “for freezing of road surface” to a warning calling attention to the slip.

Further, the communication unit 120 may be included not in the driving assistance device 12 but in an in-vehicle communication device such as a data communication module (DCM). In this case, the vehicle 10 may include the driving assistance device 12 and a DCM that can communicate with the driving assistance device 12.

Further, although the server 30 and the driving assistance device 12 cooperate and execute various processes, sharing of the processes in the above embodiment is an example. For example, the driving assistance device 12 may execute at least some of the processes that are performed by the server 30 in the above embodiment. Further, for example, the server 30 may execute at least some of the processes that are performed by the driving assistance device 12 in the above embodiment.

Further, for example, a processor mounted in a general-purpose electronic device (corresponding to the driving assistance device 12 and the server 30) such as a mobile phone, a smartphone, a tablet terminal, or a mobile computer and a server device can be caused to function as the controller 125 and the server controller 33. Specifically, the electronic device can be realized by storing a program describing processing content for realizing each function of the electronic device in a storage unit (a memory) of the electronic device and reading and executing the program using a processor of the electronic device.

What is claimed is:

1. A server comprising:
a server communication unit configured to communicate with a plurality of vehicles including a first vehicle and a second vehicle traveling behind the first vehicle; and
a server controller configured to
acquire vehicle information of the vehicles,
determine an abnormality classification of a road abnormality based on vehicle information of the first vehicle,
acquire first road information from the first vehicle,
determine correctness of the abnormality classification based on the first road information acquired from the first vehicle, and
output a warning according to the abnormality classification to the second vehicle.

2. The server according to claim 1, wherein the server controller is configured to
output a question regarding the abnormality classification to the first vehicle, and
acquire an answer to the question from the first vehicle as the first road information.

3. The server according to claim 2, wherein the question differs in content according to the abnormality classification, and is answered positively or negatively.

4. The server according to claim 1, wherein the server controller is configured to
acquire second road information from the second vehicle, and
determine elimination of the road abnormality based on the second road information acquired from the second vehicle.

5. The server according to claim 2, wherein the server controller is configured to
acquire second road information from the second vehicle, and
determine elimination of the road abnormality based on the second road information acquired from the second vehicle.

6. The server according to claim 3, wherein the server controller is configured to
acquire second road information from the second vehicle, and
determine elimination of the road abnormality based on the second road information acquired from the second vehicle.

7. The server according to claim 1, wherein the vehicle information includes at least one of a speed of the vehicles, an acceleration of the vehicles, a steering angle of the vehicles, an actual torque transmitted to wheels of the vehicles, and presence or absence of an operation of an antilock brake system of the vehicles.

8. An information processing method comprising:
causing a server to communicate with a plurality of vehicles including a first vehicle and a second vehicle traveling behind the first vehicle;
causing the server to acquire vehicle information of the vehicles;
causing the server to determine an abnormality classification of a road abnormality based on vehicle information of the first vehicle;
causing the server to acquire first road information from the first vehicle;
causing the server to determine correctness of the abnormality classification based on the first road information acquired from the first vehicle; and
causing the server to output a warning according to the abnormality classification to the second vehicle.

9. The information processing method according to claim 8 further comprising:
causing the server to output a question regarding the abnormality classification to the first vehicle; and
causing the server to acquire an answer to the question from the first vehicle as the first road information.

10. The information processing method according to claim 9, wherein the question differs in content according to the abnormality classification, and is answered positively or negatively.

11. The information processing method according to claim 8 further comprising:
causing the server to acquire second road information from the second vehicle; and
causing the server to determine elimination of the road abnormality based on the second road information acquired from the second vehicle.

12. The information processing method according to claim 9 further comprising:
causing the server to acquire second road information from the second vehicle; and
causing the server to determine elimination of the road abnormality based on the second road information acquired from the second vehicle.

13. The information processing method according to claim 10 further comprising:
causing the server to acquire second road information from the second vehicle; and
causing the server to determine elimination of the road abnormality based on the second road information acquired from the second vehicle.

14. The information processing method according to claim 8, wherein the vehicle information includes at least one of a speed of the vehicles, an acceleration of the vehicles, a steering angle of the vehicles, an actual torque transmitted to wheels of the vehicles, and presence or absence of an operation of an antilock brake system of the vehicles.

15. A non-transitory storage medium storing a program, the program causing a server to
communicate with a plurality of vehicles including a first vehicle and a second vehicle traveling behind the first vehicle,
acquire vehicle information of the vehicles,
determine an abnormality classification of a road abnormality based on vehicle information of the first vehicle,
acquire first road information from the first vehicle,
determine correctness of the abnormality classification based on the first road information acquired from the first vehicle, and
output a warning according to the abnormality classification to the second vehicle.

16. The non-transitory storage medium storing the program according to claim 15, the program further causing the server to:
output a question regarding the abnormality classification to the first vehicle; and
acquire an answer to the question from the first vehicle as the first road information.

17. The non-transitory storage medium storing the program according to claim 16, wherein the question differs in content according to the abnormality classification, and is answered positively or negatively.

18. The non-transitory storage medium storing the program according to claim 15, the program further causing the server to:
acquire second road information from the second vehicle; and
determine elimination of the road abnormality based on the second road information acquired from the second vehicle.

19. The non-transitory storage medium storing the program according to claim 16, the program further causing the server to:
acquire second road information from the second vehicle; and
determine elimination of the road abnormality based on the second road information acquired from the second vehicle.

20. The non-transitory storage medium storing the program according to claim 17, the program further causing the server to:
acquire second road information from the second vehicle; and
determine elimination of the road abnormality based on the second road information acquired from the second vehicle.
